(19) United States
(12) Patent Application Publication
(10) Pub. No.: US 2010/0014282 A1
(43) Pub. Date: Jan. 21, 2010

(54) FIRE-RESISTANT AND NOISE ATTENUATING RECESSED LIGHTING ASSEMBLY

(76) Inventor: Michael Danesh, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/173,232

(22) Filed: Jul. 15, 2008

(51) Int. Cl. F21S 8/04

(52) U.S. Cl. 362/147

(57) ABSTRACT

A fire resistant and sound-attenuating lighting assembly adapted to be recessed or mounted behind a ceiling or other surface comprising a light fixture mounted on a plaster frame and adapted to emit light through an opening in the plaster frame and an insulating blanket deployed around the light fixture except for an opening in the light fixture through which light is emitted. In one embodiment, a shell attached to the plaster frame substantially surrounds the insulating blanket. Among other things, the fire-resistant lighting assembly is capable of sustaining fire barrier standards for a ceiling or other surface and maintains the acoustic insulation of the ceiling or other surface thereby reducing noise transmission.

### FIELD OF THE DISCLOSURE

The field of the present disclosure is generally that of illumination, and particularly fire resistant and noise-attenuating recessed lighting assemblies for ceilings, walls, and floors.

### BACKGROUND

Commercial and residential buildings must usually comply with fire safety standards. This includes buildings intended for occupation or habitation, such as apartment buildings, hotels, and assisted living facilities. Residential and commercial buildings usually must satisfy a “fire-rated” floor-ceiling assembly standard. Such standards and requirements are incorporated into many building codes for various cities and municipalities.

The Underwriters Laboratories (UL) One-Hour Fire Rated L500 Ceiling Assembly test for wood or wood/steel joists with gypsum board membrane ceiling assemblies is a test used to determine the fire resistance of that particular kind of ceiling assembly. The test and method specification are covered under ANSI/UL263 (ASTM E119 and NFPA 251). (Underwriters Laboratories (UL) also has tests for other types of ceiling assemblies.) Oftentimes, passing this test will result in a certification that can be used to determine compliance with a building code or other city/state/municipality requirement. The UL test is performed on a reduced-size version of a ceiling assembly, using gas jets in a furnace to provide heat and open flame below the ceiling of the assembly. Typically, the assembly will pass the test and be certified if the temperatures recorded by thermocouples above the ceiling do not exceed a certain amount at the end of 75 minutes. A two-hour test also exists, which provides a similar UL certification. UL certification is the most prevalent type of certification in the lighting industry.

Sound transmission and pollution is also a major concern for new commercial and residential properties. Many new commercial and residential buildings are being built with smaller and smaller rooms and with units or offices that are closer to each other. As a result, more sound is transmitted between connected or nearby units or offices, which is highly undesirable for tenants and owners. Much of the sound that is transmitted from one room to another travels through the opening in the ceiling, wall, or floor of the building where light fixtures are placed. Accordingly, a lighting assembly which reduces or eliminates sound that normally would travel though the lighting assembly and into another area or room, along with providing the other desired benefits and advantages is needed.

When a recessed lighting fixture or assembly is installed, an opening in the ceiling, wall, or floor of a building must be made to accommodate it. The lighting fixture is usually placed behind the opening, making it recessed, and emits light through the opening. A ceiling-mounted light fixture usually includes a light-emitting element such as a fluorescent, incandescent or high intensity discharge lamp, a housing or “can” for reflecting light surrounding the light-emitting element, and a plaster frame with bar hangers. A hole is cut in the ceiling and the light fixture is mounted above the hole by attaching the bar hangers to joists so that the light fixture is mounted between the joists and above the hole in the ceiling so that light from the light-emitting element will pass through the hole.

When holes or openings are created in the ceiling, wall, or floor, the integrity of a ceiling, wall, or floor that is otherwise fire-rated and somewhat sound resistant is compromised. This is because the ceiling, wall, or floor no longer has continuous fire-rated and sound resistant assemblies. The hole or opening may allow heat, flames and sound to pass through the ceiling, wall, or floor and into the space behind the ceiling, wall, or floor and into nearby areas. The ceiling, wall, or floor therefore may no longer satisfy fire safety standards and allow unwanted sound when recessed light fixtures are installed behind the holes or openings in the ceiling, wall, or floor.

In an attempt to solve at least some of these problems, builders have constructed boxes of fire resistant material, such as dry wall or gypsum board, around the light fixtures in order to try and restore at least some portion of the “continuity” and thus the fire integrity of the ceiling, wall, or floor. These “fire boxes” are constructed as needed and require additional time and expense to be expended by the builder. Moreover, these hand made fire boxes are often poorly constructed and do not have the benefit of standardization or certification and add unnecessary expense and difficulty to the construction process. Additionally, these fireboxes often do not provide the required fire protection or the desired attenuation of noise, which is highly desirable in both commercial and residential settings.

Since the beginning of the current decade manufacturers have tried to address some of these problems. For example, Cubicles Plus, Inc. sells a “fire box” under the trademark E.Z. BARRIER® that replaces manually built fire barriers around recessed light fixtures and “will maintain the one hour fire rating required for installation of recessed devices within a rated assembly,” although the cited standard is an outdated one from ASTM International and is not that of Underwriters Laboratories. The E.Z. BARRIER® firebox appears to be a metal box with an opening that fits over a recessed lighting assembly and is attached to the joists on either side of the recessed lighting assembly. The E.Z. BARRIER® firebox is supplied separately from the recessed lighting assembly and requires additional installation labor. The E.Z. BARRIER® firebox is also very large and often requires addition construction or modification of the ceiling where it is being installed, requiring additional time, effort and expense and potentially compromising the structural and fire-resistant integrity of the ceiling. Moreover, among other things, the E.Z. BARRIER® does not provide the level of fire protection that is desired and often required in many commercial and residential settlings and offer little to no noise-attenuation benefit.

Other solutions proposed in the prior art, including those disclosed in U.S. Pat. No. 6,357,891 and its continuations-in-part, U.S. Pat. Nos. 6,838,618 and 7,114,294, the disclosures of which are incorporated herein by reference for all purposes, do not provide the benefits and advantages of the present invention. For example, and not by way of limitation, those disclosures provide for assemblies that provide inferior fire-resistant qualities and little to no noise attenuation. Many if not all of the assemblies disclosed in the prior art are heavy due to the use of various layers of dry wall, wallboard, and the like. In addition, many of the prior art assemblies are complex and expensive to build due to a design that requires assembly of several walls of fire-resistant material onto a support structure. Often times, they disclose assemblies where the walls must be doubled in order to provide a structure that can achieve a suitable amount of fire-resistance (e.g., two hour UL rating), which add considerably to the weight and makes construction and installation difficult. Additionally, the assemblies disclosed in the prior art are bulky, have numerous corners where the fire-resistant material comes together creating weak points and provide little to no sound attenuation thereby preventing sound from leaving the assembly. Furthermore, many of the prior art assemblies having exposed rough dry wall, which can be easily damaged during installation and use and provides a messy and undesirable appearance.

Accordingly, a need exists for a preassembled fire-resistant and sound-attenuating recessed lighting assembly that, among other things, is simpler, lighter, easier to make while enabling the ceiling, wall, or floor to achieve superior fire-resistance and acoustic ratings. The present invention provides these and other benefits and advantages.

### SUMMARY OF THE DISCLOSURE

The present disclosure provides, in one aspect, a fire-resistant and sound-attenuating recessed lighting assembly comprising a light fixture adapted to be placed behind the opening in a surface such as a ceiling, wall, or floor and with an insulation blanket substantially surrounding the light fixture except for the opening. A shell may enclose the insulation blanket.

In another aspect, the present disclosure provides a fire-resistant and sound-attenuating lighting assembly, comprising a light fixture having an opening for emitting light; and an insulation blanket adapted to substantially enclose the light fixture except for the opening; wherein the light fixture is adapted to be mounted behind a surface opening defined by a surface of an adjoining wall structure so that the opening of the light fixture is adjacent the surface opening.

In yet another aspect, the present disclosure provides a fire-resistant and sound-attenuating lighting assembly, comprising a light fixture having an opening through which light is emitted and adapted to be mounted behind a surface having an opening through which the light passes; an insulation blanket adapted to substantially enclose the light fixture except for the opening in the light fixture; and a shell substantially enclosing the insulation.

In still another aspect, the present disclosure provides a fire-resistant and sound-attenuating lighting assembly, comprising a plaster frame having an opening therein; a light fixture attached to the plaster frame wherein the light fixture is substantially above the plaster frame and light emitted by the light fixture passes through the opening in the plaster frame; an insulation blanket adapted to substantially enclose the light fixture above the plaster frame; and a shell attached to the plaster frame and adapted to substantially enclose the insulation blanket.

In yet another aspect, the present disclosure provides a fire-resistant and sound-attenuating recessed ceiling lighting assembly adapted to be mounted between two joists of a ceiling structure and above a ceiling panel, comprising a plaster frame having an upper side and a lower side and an opening therebetween; at least one adjustable bar hanger attached to the plaster frame, wherein the adjustable bar hangar has two bars adapted for attachment to spaced joists; a light fixture having an opening, wherein the light fixture is attached to the plaster frame so that the light fixture is substantially located above the upper side of the plaster frame so that the opening in the light fixture is adjacent the opening in the plaster frame; a junction box attached to the plaster frame and in electrical connection with the light fixture; a fire-resistant container attached to the upper side of the plaster frame wherein the fire-resistant container comprises a shell defining a compartment having an opening in the shell communicating with the compartment wherein the compartment is adapted so that the light fixture is substantially contained within the compartment when the shell is attached to the plaster frame; and an insulation blanket placed between the shell and the light fixture wherein the insulation blanket substantially encloses the housing above the opening in the housing.

It should be appreciated that the various embodiments of the fire-resistant and sound-attenuating recessed ceiling lighting assembly disclosed herein can be used with any type of light source, including but not limited to incandescent light bulb, halogen lamp, fluorescent lamp, LED lamp, carbon arc lamp, discharge lamp and any other type of light source known in the art of later developed.

Other objects, features and aspects of the present disclosure are discussed in greater detail below.

### BRIEF DESCRIPTION OF THE DRAWINGS

The present invention will be understood and appreciated more fully from the following detailed description taken in conjunction with the drawings. The accompanying drawings, which constitute part of this specification, help to illustrate an embodiment of the disclosure. In the drawings, like numerals are used to indicate like elements throughout. The drawings are described below.

FIG. 1 is a side elevational view of a preferred embodiment of a fire-resistant recessed lighting assembly according to the present disclosure, with a partial cutaway;

FIG. 2 is an exploded view of the lighting assembly of FIG. 1;

FIG. 3 is a perspective view of the shell and the insulation of the lighting assembly according to FIG. 1; and

FIG. 4 is an exploded view of the shell and the insulation of FIG. 3.

FIG. 5 is a chart demonstrating the sound-attenuating features of the FIREMASTER® 607 blanket by graphically demonstrating the sound absorption coefficient at various sound frequencies in accordance with at least one-embodiment of the present disclosure.

FIG. 6 is a chart demonstrating the sound-attenuating features of the FIREMASTER® 607 blanket by graphically demonstrating the sound transmission loss at various sound frequencies in accordance with at least one-embodiment of the present disclosure.

### DETAILED DESCRIPTION OF THE PREFERRED EMBODIMENTS

For the purposes of this specification, unless otherwise indicated, all numbers expressing quantities of ingredients and so forth used in the specification are to be understood as being modified in all instances by the term “about.” Accordingly, unless indicated to the contrary, the numerical parameters set forth in the following specification are approximations that can vary depending upon the desired properties sought to be obtained by the present disclosure.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub ranges subsumed therein, and every number between the end points. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

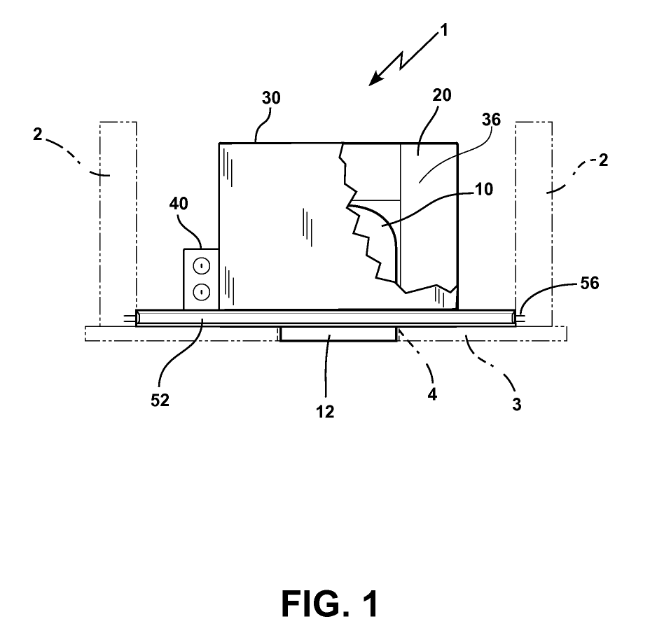

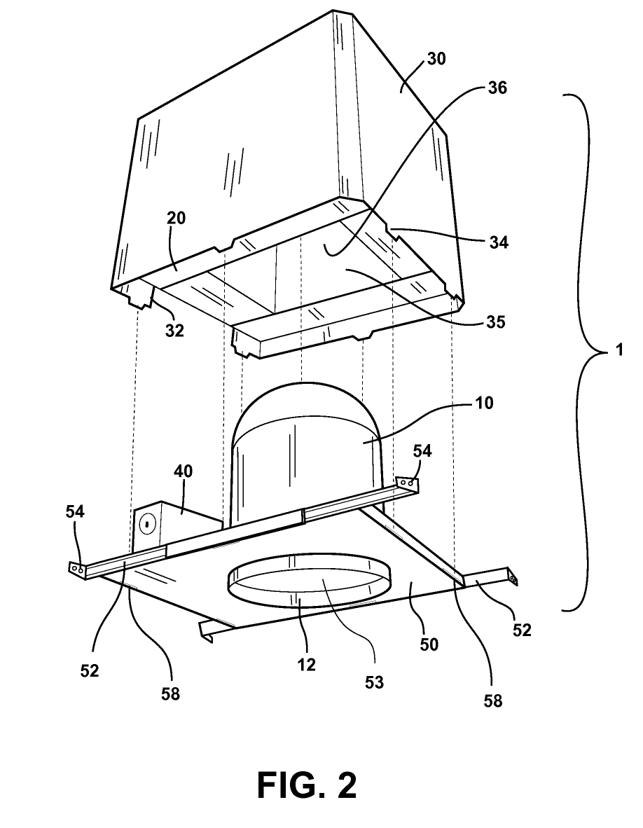

One embodiment of the present disclosure, a fire-resistant and sound-attenuating recessed lighting assembly is provided. In at least one embodiment, the assembly is shown in FIG. 1. The lighting assembly 1 is shown attached to two parallel joists 2 above a ceiling 3. The lighting assembly 1 comprises a light fixture 10. Insulation in the form of an insulating blanket 20 surrounds the light fixture 10 above the ceiling 3. A shell 30 surrounds the insulating blanket 20. A plaster frame or base 50 (see FIG. 2) supports the light fixture 10, the insulating blanket 20, the shell 30, and a junction box 40. Bar hangers 52 attach the plaster frame 50 to the joists 2 and support the lighting assembly 1. The ceiling 3 may be made of gypsum board, stucco or other suitable fire-resistant materials. The materials of the ceiling may be doubled or thickened in order to increase fire resistance.

The insulating blanket can be comprised of any somewhat flexible fire-resistant material. For example and not to limit the scope of the materials the insulating blanket can be made of in any way, the fire-resistant insulating-blanket can be make of combinations of rock wool, gypsum, perlite, vegetable or silicate fibers, calcium silicate and magnesium silicate.

In at least one embodiment, the insulating blanket is comprised of a fire-resistant calcium-magnesium-silicate fiber.

In at least one embodiment, the insulating blanket is comprised of a fire-resistant calcium-magnesium-zirconium-silicate wool.

In at least one embodiment, the insulating blanket is comprised of fire-resistant alkaline earth silicate fibers.

The light fixture 10 can include any kind of suitable light fixture. In the preferred embodiment, the light fixture 10 is a recessed light fixture in which a housing or “can” contains a lighting element (not shown in the drawings). The can may contain a reflector or a baffle. The light fixture 10 preferably is UL certified and preferably may be provided in a variety of sizes, such as three inch, four inch, five inch, and six inch, although it will be understood that UL certification and the suggested sizes are not required and are not to be considered to limit the present disclosure.

The light fixture 10 has a flange 12 that projects through an opening in the plaster frame 50 and through an opening 4 in the ceiling 3 so that the flange 12 is flush with the lower surface of the ceiling 3. The flange 12 may be made to be adjustable vertically by fastening the light fixture 10 to the plaster frame 50 at higher or lower positions. This adjustability would be useful to accommodate ceilings of different thicknesses. The provision of a flange 12 is preferred as trim because it conceals the edge of the ceiling 3 at the opening 4. It also keeps the light fixture 10 aligned with the opening 4 in the ceiling 3. The flange 12, although preferred in the context of a recessed lighting assembly, is not required. It also will be understood that the flange 12 could be formed as part of the plaster frame 50 rather than the light fixture 10, if desired.

It also will be understood by those of skill in the art to which this disclosure pertains that the light fixture can contain any of a variety of lighting elements, such as, but not limited to, incandescent, fluorescent or High Intensity Discharge lighting elements. Furthermore, it also will be understood by those of skill in the art to which this disclosure pertains that the can may have a shape that is round, square, octagonal or any of a variety of shapes and may be made of any suitable material, such as mild steel.

The plaster frame 50 is best seen in FIG. 2 and is a generally rectangular sheet of metal with bar hangers 52 attached on opposed parallel sides. The plaster frame 50 supports the light fixture 10 and has an opening 53 through which the flange 12 of the light fixture 10 protrudes downwardly from the lower surface of the plaster frame 50. The plaster frame 50 also supports the junction box 40 on its upper surface.

The bar hangers 52 are of a conventional design and comprise two overlapping arms in a sliding relationship. Opposed ends of the sliding arms have flanges or feet with holes 64 for receiving nails 66 for attachment to the joists 2.

It will be understood that other means for attachment of the bar hangers 52 to the joists 2 may be employed, such as screws, self-tapping bolts, and the like. It also will be understood that the lighting assembly 1 may be supported by other means such as butterfly attachments and the like.

The junction box 40 is provided to allow an electrician to wire the lighting assembly 1 to the mains, other lighting fixtures, and the like by means well known to those of skill in the art. The junction box 40 is currently preferred but not indispensable.

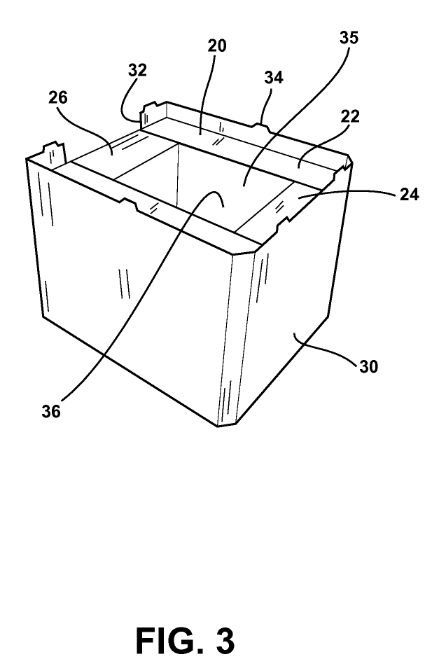

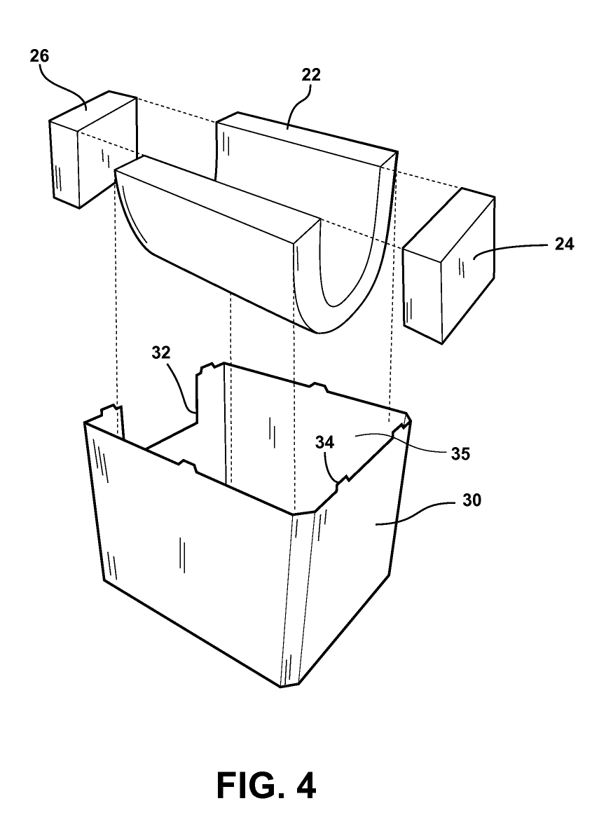

The insulating blanket 20 preferably comprises the three insulation sheets 22, 24, and 26. As is best seen in FIG. 4, the insulation sheets 22, 24, and 26 are cut to fit and simply placed inside the shell 30 so that the shell 30 is lined with the insulation 20 as shown in FIG. 3. The insulation sheets 22, 24, and 26 preferably are not attached to the shell 30 by gluing, mechanical attachment and the like in order to avoid an unnecessary step. The insulation sheets 22, 24, and 26 have sufficient resilience to maintain their position once inside the shell 30. The shell 30 holds the insulation sheets 22, 24, and 26 together to form the insulating blanket 20 and protects them from contamination, soiling, impact, crushing, deformation, abrasion, and other forms of rough handling as well as from water damage.

A currently preferred material for the insulation sheets 22, 24, and 26 is a fire-resistant fiber product in a blanket form. This product provides both thermal and acoustic insulation.

Thermal Ceramics sells an acceptable fiber product in blanket form under its trademark FIREMASTER®. FIREMASTER® 607 blanket is a non-combustible, flexible matt manufactured from alkaline earth silicate fibers that can be provided in various thicknesses and densities. It provides good fire protection at a range of temperatures for lower weight and thickness than most mineral fiber compositions. It is also an excellent acoustic insulation material. It is safer to handle because it is designed to have enhanced solubility in lung tissue. The FIREMASTER® 607 blanket is capable of providing the desired thermal and acoustic insulation without the aid of the shell 30 as long as the FIREMASTER® 607 blanket can be kept in position adjacent the light fixture 10. The shell 30 is provided to protect the material of the insulating blanket 20 as well as to secure it in position adjacent the light fixture 10.

Another material that could be used for the insulation sheet is a vitreous (non-crystalline) aluminosilicate fiber also known as man-made mineral fiber (MMMF) or synthetic vitreous fiber (SVF). This is a refractory ceramic fiber material that is a white, odorless, wool-like fibrous material with a melting point of about 1760° C. (3200° F.).

The advantage of using an insulation blanket for the insulation is that this material is lighter, has superior thermal and acoustic insulation qualities, and is easy to shape and assemble into position in the lighting assembly.

The insulation sheets 22, 24, and 26 are easily cut from a roll of this material by a sharp knife or shears. It will be understood that the insulation sheets 22, 24, and 26 may be cut into pieces of different shapes than those shown in FIG. 4 as long as the insulation sheets 22, 24, and 26 surround the light fixture 10 above the plaster frame 50. Preferably, the insulation sheets 22, 24, and 26 will be adjacent the light fixture 10 as well as the shell 30 so that the insulation sheets are held in place between the light fixture 10 and the shell 30.

The insulating blanket 20 may be preformed by the manufacturer into an appropriate shape for placing around the light fixture 10 rather than being cut out of blanket material. This will have the advantage of not requiring a shell 30 to hold the shape of the blanket 20 although the shell 30 would still be useful for protection of the blanket 20 from the various hazards described above. However, this will increase the expense of the insulation component of the lighting assembly 1.

The shell 30 is placed over the light fixture 10 on the plaster frame 50 as shown in FIGS. 1 and 2. The opening 35 in the shell 30 receives the light fixture 10 in a compartment 36 formed by the shell 30. The edge of the shell 30 at its opening 35 has tabs 34 formed therein that mate with the corresponding slots 58 in the plaster frame 50 for securing the shell 30 to the plaster frame 50.

The shell 30 is preferably made of a mild steel or aluminum alloy on account of the cost. Other metals, such as nickel, copper, and high temperature magnesium alloy are acceptable. The shell 30 also could be made of non-metallic material, such as a fiberglass or thermoplastic. Preferably, the shell 30 is cut out of a single sheet of metal and folded into position. The walls of the shell 30 can be joined together in any suitable way such as stamping, pop riveting, welding, crimping and the like.

The shell 30 shown in the drawings is in the form of a cube with an opening 35 at its bottom but it will be understood that other shapes, such as cylindrical, are possible and will be acceptable.

The shell 30 has a cutout 32 on one side to accommodate the junction box 40 when the shell 30 is in place on the plaster frame 50. The cutout 32 permits a portion of the junction box 40 to enter the interior of the shell 30 for the purpose of electrical connection with the light fixture 10. It will be understood that this configuration is not essential. For example, the junction box 40 could be located entirely outside the shell 30 and the electrical connection could be achieved through smaller openings in the shell 30.

It will be noted that the assembly of the fire-resistant container 20 is much simpler and easier to make than that of the “firebox” lighting assembly disclosed in the background. It has fewer parts and requires fewer steps in assembly. It is also lighter.

The lighting assembly 1 has been demonstrated to maintain the fire rating of a ceiling assembly. A test sample of a lighting assembly 1 was constructed as described above, using the preferred materials, namely, an insulating blanket 20 made of one and one-half inch thick FIREMASTER® 607 blanket material inside a shell 30 made of a mild steel. (The thickness of the FIREMASTER® 607 blanket material is measured when it is stored on a roll; the material expands when it is removed from the roll.)

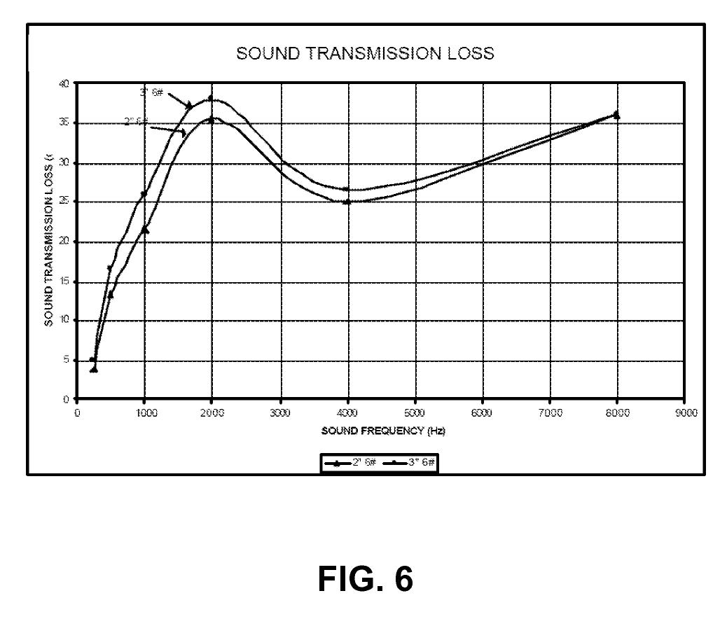

The test sample of a lighting assembly 1 was then tested according to the UL standard discussed in the background section of this disclosure, in which the fixture is mounted in a section of a ceiling structure comprising joists supporting a gypsum board ceiling. Thermocouples measured the temperatures in areas between the joists (joist cavities) with and without the lighting assembly. FIG. 6 of U.S. Pat. No. 6,357,891 (discussed in the background section above and incorporated by reference) provides diagrams showing the locations of the thermocouples used in this test.

After a 75 minute period of fire exposure, the test sample of a lighting assembly 1 was found to adequately comply with the applicable UL standard for a one-hour fire rating. In particular, the temperature of the joist cavity containing the test sample was compared to the temperature of the joist cavity not containing the test sample. The joist cavity with the test sample had a lower overall temperature than the joist cavity without the test sample and this discrepancy increased with time. The UL standard merely requires that the joist cavity with the test sample not become more than 5% hotter.

The test was continued for seventy-five minutes with the same result. Although a two-hour test has yet to be completed, it is expected that a test sample of a lighting assembly 1 would pass a two-hour test just as well as the one-hour test and meet that particular UL standard. The two-hour test is applicable to ceilings with a double layer of gypsum board.

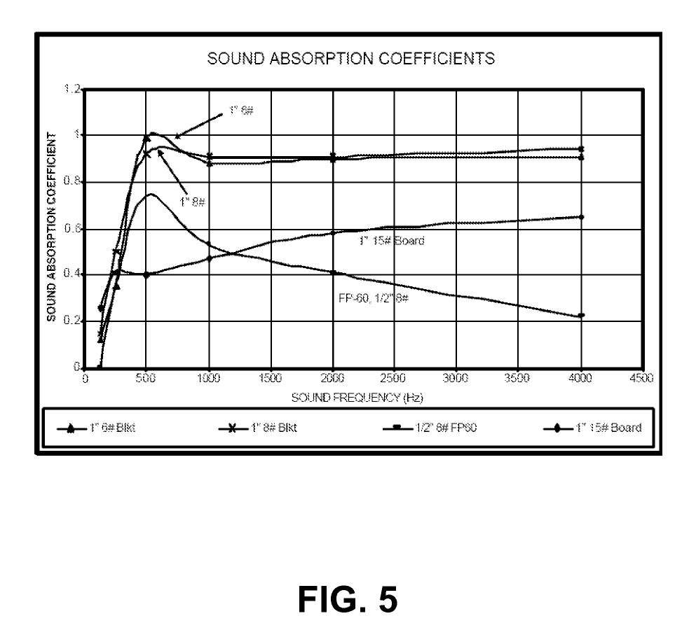

The lighting assembly 1 also provides superior acoustic insulation. It is a well-known phenomenon of buildings that house a number of people, especially multistory apartment buildings and the like, that sound readily travels from one apartment to another, especially vertically. Just as providing holes in a ceiling will compromise the fire rating of the ceiling, its capability as an acoustic barrier is likewise compromised. The insulative blanket 20 adds an acoustic barrier as well as a fire-resistant one. It is believed that the superior acoustic insulative property of the lighting assembly 1 is due to the thicker insulation provided by the insulation sheets compared to prior insulated lighting assemblies such as that of U.S. Pat. No. 6,357,891 and add-on devices such as the E.Z. BARRIER® fire protection product. FIG. 5 demonstrates the acoustic insulation and sound absorption qualities of lighting assembly 1 and other embodiments covered by the present disclosure.

In yet another embodiment, a fire resistant and sound-attenuating lighting assembly is provided. The assembly includes a light fixture having an opening for emitting light and an insulation blanket adapted to substantially enclose the light fixture except for the opening. The insulating blanket can be made of any material that is both somewhat fire resistant and sound-attenuating. The light fixture is adapted to be mounted behind a surface opening defined by a surface of an adjoining wall structure so that the opening of the light fixture is adjacent the surface opening.

In yet another aspect of at least one embodiment of the present disclosure, the insulation blanket provides enough insulation to pass the one-hour or two-hour Fire Rated L500 Ceiling Assembly test and where the sound absorption provides a sound absorption coefficient of 0.4 to 1.1 for sound frequencies between 500 and 2000 hertz.

In yet another aspect of at least one embodiment of the present disclosure, the insulation blanket comprises at least one continuous piece of flexible material that substantially encloses at least two sides of the light fixture. By being a continuous piece of flexible material, the insulation blanket allows the assembly to have superior fire resistant and sound dampening/attenuation qualities. Additionally, the continuous piece of flexible material acts to trap or isolate the heat and sound preventing it from escaping to undesirable areas. Moreover, the continuous piece of flexible material allows the assembly to be easily constructed and be more durable and long-lasting when compared to prior art fire-resistant assemblies.

In yet another aspect of at least one embodiment of the present disclosure, the insulation blanket is capable of substantially maintaining the fire rating of the floor-ceiling assembly after the fire-resistant lighting assembly is installed into or next to the floor-ceiling assembly.

In yet another aspect of at least one embodiment of the present disclosure, the lighting assembly is capable of being Underwriters Laboratories-certified for maintaining a fire rating in a UL L500, D500, G500, D200, G200, or L200 floor/ceiling assemblies for one hour or less.

In yet another aspect of at least one embodiment of the present disclosure, the lighting assembly is capable of being Underwriters Laboratories-certified for maintaining a fire rating in UL L500, D500, G500, D200, G200, or L200 floor/ceiling assemblies of up to two hours.

In yet another aspect of at least one embodiment of the present disclosure, the insulating blanket is a non-combustible matt.

In yet another aspect of at least one embodiment of the present disclosure, the insulation blanket is substantially comprised of alkaline earth silicate fibers.

In yet another aspect of at least one embodiment of the present disclosure, the insulation blanket is substantially comprised of refractory ceramic fibers.

In yet another aspect of at least one embodiment of the present disclosure, the refractory ceramic fibers are vitreous silicate fibers.

In yet another aspect of at least one embodiment of the present disclosure, the fire-resistant and sound-attenuating lighting assembly further comprises a shell substantially enclosing the light fixture and the insulation blanket except for the opening in the light fixture.

In yet another aspect of at least one embodiment of the present disclosure, the fire-resistant and sound-attenuating lighting assembly further comprises a plaster frame to which the light fixture and the shell are attached.

In yet another aspect of at least one embodiment of the present disclosure, the insulating blanket is adjacent to the light fixture and secured in place by the shell.

In yet another aspect of at least one embodiment of the present disclosure, the insulating blanket comprises at least one piece of a non-combustible flexible matt.

In another embodiment of the present disclosure, a fire-resistant and sound-attenuating lighting assembly is provided. The assembly comprises a light fixture having an opening through which light is emitted and adapted to be mounted behind a surface having an opening through which the light passes, a flexible insulation blanket adapted to substantially enclose the light fixture except for the opening in the light fixture and a shell substantially enclosing the insulation blanket. The flexible insulation blanket comprises at least one continuous piece of flexible material that substantially encloses at least two sides of the light fixture.

In yet another embodiment of the present invention, a fire-resistant and sound-attenuating lighting assembly is provided. The assembly comprises a plaster frame having an opening in the assembly, a light fixture attached to the plaster frame wherein the light fixture is substantially above the plaster frame and light emitted by the light fixture passes through the opening in the plaster frame, a flexible insulation blanket adapted to substantially enclose the light fixture above the plaster frame and a shell attached to the plaster frame and adapted to substantially enclose the insulation.

In yet another aspect of at least one embodiment of the present disclosure, the assembly further comprises a junction box attached to the plaster frame and in electrical connection with the light fixture.

In another embodiment of the present disclosure, a fire-resistant and sound-attenuating recessed ceiling lighting assembly adapted to be mounted between two joists of a ceiling structure and above a ceiling panel is provided. The assembly comprises a plaster frame having an upper side and a lower side and an opening therebetween, at least one adjustable bar hanger attached to the plaster frame, wherein the adjustable bar hangar has two bars adapted for attachment to spaced joists, a light fixture having an opening where the light fixture is attached to the plaster frame so that the light fixture is substantially located above the upper side of the plaster frame so that the opening in the light fixture is adjacent the opening in the plaster frame, a junction box attached to the plaster frame and in electrical connection with the light fixture, a fire-resistant container attached to the upper side of the plaster frame wherein the fire-resistant container comprises a shell defining a compartment having an opening in the shell communicating with the compartment wherein the compartment is adapted so that the light fixture is substantially contained within the compartment when the shell is attached to the plaster frame and a flexible insulation blanket placed between the shell and the light fixture wherein the insulation substantially encloses the housing above the opening in the housing where the flexible insulation blanket comprises at least one continuous piece of flexible material that substantially encloses at least two sides of the light fixture.

While an illustrative embodiment of a fire-resistant recessed lighting assembly disclosed herein has been shown and described in the above description, numerous variations and alternative embodiments will occur to those skilled in the art and it should be understood that, within the scope of the appended claims, the invention may be practiced otherwise than as specifically described. Such variations and alternative embodiments are contemplated, and can be made, without departing from the scope of the invention as defined in the appended claims.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A fire resistant and sound-attenuating lighting assembly, comprising:
a light fixture having an opening for emitting light; and
an insulation blanket adapted to substantially enclose the light fixture except for the opening;
wherein the light fixture is adapted to be mounted behind a surface opening defined by a surface of an adjoining wall structure so that the opening of the light fixture is adjacent the surface opening.

2. The fire resistant and sound-attenuating lighting assembly according to claim 1 wherein the insulation blanket provides thermal insulation and sound absorption.

3. The fire-resistant and sound-attenuating lighting assembly according to claim 2 wherein the thermal insulation provides enough insulation to pass the one-hour or two-hour Fire Rated L500 Ceiling Assembly test and where the sound absorption provides a sound absorption coefficient of 0.4 to 1.1 for sound frequencies between 500 and 2000 hertz.

4. The fire-resistant and sound-attenuating lighting assembly according to claim 1 wherein the insulation blanket comprises at least one continuous piece of flexible material that substantially encloses at least two sides of the light fixture.

5. The fire-resistant and sound-attenuating lighting assembly according to claim 1, wherein the adjoining wall structure comprises a floor-ceiling assembly, said floor-ceiling assembly having a fire rating, and wherein the insulation blanket is capable of substantially maintaining the fire rating of the floor-ceiling assembly after the fire-resistant lighting assembly is installed.

6. The fire-resistant and sound-attenuating lighting assembly according to claim 5 wherein the lighting assembly is capable of being Underwriters Laboratories-certified for maintaining a fire rating in a UL L500, D500, G500, D200, G200, or L200 floor/ceiling assembly for one hour or less.

7. The fire-resistant and sound-attenuating lighting assembly according to claim 1 wherein the lighting assembly is capable of being Underwriters Laboratories-certified for maintaining a fire rating in UL L500, D500, G500, D200, G200, or L200 floor/ceiling assemblies of two or more hours.

8. The fire-resistant and sound-attenuating lighting assembly according to claim 4 wherein the insulating blanket is a non-combustible matt.

9. The fire-resistant and sound-attenuating lighting assembly according to claim 1 wherein the insulation blanket is substantially comprised of alkaline earth silicate fibers.

10. The fire-resistant and sound-attenuating lighting assembly according to claim 1 wherein the insulation blanket is substantially comprised of refractory ceramic fibers.

11. The fire-resistant and sound-attenuating lighting assembly according to claim 10 wherein the refractory ceramic fibers are vitreous silicate fibers.

12. The fire-resistant and sound-attenuating lighting assembly according to claim 1 further comprising a shell substantially enclosing the light fixture and the insulation blanket except for the opening in the light fixture.

13. The fire-resistant and sound-attenuating lighting assembly according to claim 12 further comprising a plaster frame to which the light fixture and the shell are attached.

14. The fire-resistant and sound-attenuating lighting assembly according to claim 13 wherein the insulating blanket is adjacent to the light fixture and secured in place by the shell.

15. The fire-resistant and sound-attenuating lighting assembly according to claim 14 wherein the insulating blanket comprises at least one piece of a non-combustible flexible matt.

16. A fire-resistant and sound-attenuating lighting assembly, comprising:
a light fixture having an opening through which light is emitted and adapted to be mounted behind a surface having an opening through which the light passes;
a flexible insulation blanket adapted to substantially enclose the light fixture except for the opening in the light fixture;
a shell substantially enclosing the insulation blanket; and
wherein the flexible insulation blanket comprises at least one continuous piece of flexible material that substantially encloses at least two sides of the light fixture.

17. The fire-resistant and sound-attenuating lighting assembly according to claim 16 wherein the shell is adapted to protect the insulation blanket from exterior forces.

18. A fire-resistant and sound-attenuating lighting assembly, comprising:
a plaster frame having an opening therein;
a light fixture attached to the plaster frame wherein the light fixture is substantially above the plaster frame and light emitted by the light fixture passes through the opening in the plaster frame;
a flexible insulation blanket adapted to substantially enclose the light fixture above the plaster frame; and
a shell attached to the plaster frame and adapted to substantially enclose the insulation.

19. The fire-resistant and sound-attenuating lighting assembly according to claim 18, further comprising a junction box attached to the plaster frame and in electrical connection with the light fixture.

20. A fire-resistant and sound-attenuating recessed ceiling lighting assembly adapted to be mounted between two joists of a ceiling structure and above a ceiling panel, comprising:
a plaster frame having an upper side and a lower side and an opening therebetween;
at least one adjustable bar hanger attached to the plaster frame, wherein the adjustable bar hangar has two bars adapted for attachment to spaced joists;
a light fixture having an opening, wherein the light fixture is attached to the plaster frame so that the light fixture is substantially located above the upper side of the plaster frame so that the opening in the light fixture is adjacent the opening in the plaster frame;
a junction box attached to the plaster frame and in electrical connection with the light fixture;
a fire-resistant container attached to the upper side of the plaster frame wherein the fire-resistant container comprises:
a shell defining a compartment having an opening in the shell communicating with the compartment wherein the compartment is adapted so that the light fixture is substantially contained within the compartment when the shell is attached to the plaster frame; and
a flexible insulation blanket placed between the shell and the light fixture wherein the insulation substantially encloses the housing above the opening in the housing;
wherein the flexible insulation blanket comprises at least one continuous piece of flexible material that substantially encloses at least two sides of the light fixture.
